(19) United States
(12) Patent Application Publication
(10) Pub. No.: US 2003/0035582 A1
(43) Pub. Date: Feb. 20, 2003

(54) Dynamic scanner

(76) Inventor: Christian Linhart, Salzburg (AT)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/929,448

(22) Filed: Aug. 14, 2001

(51) Int. Cl. G06K 9/62

(52) U.S. Cl. 382/209

(57) ABSTRACT

A method for generating a scanner includes receiving a definition of a plurality of patterns and receiving a definition of a respective association between each of the plurality of patterns and a respective executable action. The plurality of patterns and the respective associations are processed so as to form a scanner data structure capable of comparing input data to at least one of the patterns and causing execution of the associated executable action upon a match of the input data with the respective one of the plurality of patterns. The processing and the comparing are performed in the same active process.

### BACKGROUND INFORMATION

In the computer science field, a scanner is a program for comparing a data stream to a set of predefined patterns. When a pattern is matched, an action which has been defined for the pattern is executed. Scanners may be stand-alone programs or included in other applications, such as parsers, compiler front ends, text editors for syntax highlighting, and text filters.

A scanner may be produced using a scanner-generator. A typical prior scanner generator, such as Flex (University of California at Berkeley open source software), reads definitions of patterns and associated actions from a scanner definition file at build time, i.e., before compiling of the generated scanner and outside of the active process in which the scanner is run. The scanner definition file may also include a list of start states associated with each pattern, the start states being used to activate a set of patterns for scanning during running of the generated scanner. The scanner-generator processes the scanner definition file and generates a scanner in form of tables and some source code, usually in C/C++. The tables are a representation of the patterns and associated actions suitable for performing the scanner matching operations. As such, the tables act as a type of finite state machine.

The scanner is typically compiled and included with a main program which may then be run at run time, i.e., the time when the scanner machine code, as well as the machine code of any program in which the scanner is included, is executed. When run, the scanner reads data from a byte stream and performs a matching operation using the tables which were pre-generated at build time. When a match with an active pattern is found, the action, or code, associated with the pattern is executed. The pattern-matching process is very fast due to the way the patterns are processed to form a finite state machine.

Prior scanner generators are inflexible in the sense that the start states and patterns and associated action tables are fixed prior to run time. The user therefore has no ability to modify the tables, and therefore the scanner itself, without exiting the active process. Instead, the user must edit the scanner definition file as source code, run the scanner generator, recompile the generated scanner, and then restart the program, yielding another active process.

### SUMMARY

In accordance with a first embodiment of the present invention, a method for generating a scanner is provided. The method includes: receiving a definition of a plurality of patterns; receiving a definition of a respective association between each of the plurality of patterns and a respective executable action; and processing each of the plurality of patterns and the respective associations to form a scanner data structure capable of comparing input data to each of the plurality of patterns and causing execution of the associated executable action upon a match of the input data with the respective one of the plurality of patterns, the processing and the comparing being performed in a same active process.

In accordance with a second embodiment of the present invention, a method for scanning input data is provided. The method includes: receiving a definition of a plurality of patterns; receiving a definition of a respective association between each of the plurality of patterns and a respective executable action; processing the plurality of patterns and the respective associations so as form a scanner data structure; comparing the input data to the a plurality of patterns using the scanner data structure; and when the comparing results in a matched one of the a plurality of patterns, executing the respective executable action associated with the matched pattern; wherein the processing and the comparing are performed in a same active process.

In accordance with a third embodiment of the present invention, a scanner is provided. The scanner includes a scanner data structure including processed information for a plurality of patterns and respective indicators for associating a respective executable action with each of the a plurality of patterns, the scanner data structure being capable of being used to compare input data to the plurality of patterns and cause execution of the respective executable action upon a match of the input data with a one of the a plurality of patterns, the scanner data structure being formed and the comparing being performed in a same active process.

In accordance with a fourth embodiment of the present invention, the present invention provides a computer readable medium having stored thereon computer executable process steps operative to perform a method for generating a scanner. The method includes: defining a plurality of patterns; defining a respective association between each of the plurality of patterns and a respective executable action; and processing the plurality of patterns and the respective associations so as to form a scanner data structure capable of comparing input data to each of the plurality of patterns and causing execution of the respective executable action upon a match of the input data with a one of the plurality of patterns, the processing and the comparing being performed in a same active process.

### BRIEF DESCRIPTION OF THE DRAWINGS

FIG. 1 shows a flow chart of a prior art method for generating a scanner.

FIG. 2 shows a schematic block diagram of a prior art scanner definition file.

FIG. 3 shows a flow chart of a method for generating a scanner according to an embodiment of the present invention.

FIG. 4 shows a flow chart detailing the processing step (Step 206) of the flow chart of a method for generating a scanner depicted in FIG. 3.

FIG. 5 shows a flow chart of a method for generating a scanner according to an embodiment of the present invention using a saved scanner data structure.

FIG. 6 shows a flow chart of a method for generating a scanner according to an embodiment of the present invention using start states associated with patterns to be scanned for.

### DETAILED DESCRIPTION

As described above, the present invention provides a method for generating a scanner. The method in accordance with certain embodiments of the invention includes receiving a definition of a plurality of patterns, receiving a definition of a respective association between each of the plurality of patterns and a respective executable action, and processing each of the plurality of patterns and the respective associations to form a scanner data structure capable of comparing input data to each of the plurality of patterns and causing execution of the associated executable action upon a match of the input data with the respective one of the plurality of patterns, the processing and the comparing being performed in a same active process.

The scanner may be defined and run in a same active process. This increases flexibility. The user may specify the patterns to be searched, as well as the associated actions, at run time. The patterns and actions may be a result of some other computation and may be derived from different sources, enabling more flexible modularization of software. The patterns and actions may be computed automatically before being entered into the scanner definition framework, enabling support of sophisticated applications required filtering or pattern-recognition functionality.

The scanner may, for example, be used for at least one of a compiler front end, a syntax-highlighting editor, a text stream filter, a parser and a parser-filter.

In certain embodiments, receiving a definition of the plurality of patterns is performed in the same active process. Furthermore, receiving a definition of the respective associations may be performed in the same active process. The plurality of patterns may include regular expressions and/or text patterns, for example.

Each respective association between each of the plurality of patterns and the respective executable action may include a pointer, an index number, and/or a respective action object.

At least a portion of at least one of the executable actions may be generated in the same active process. At least one of the executable actions may include respective program code. Additionally, in some embodiments of the present invention, at least one of the executable actions may include respective data.

The processing may include forming a scanner definition string from the plurality of patterns and respective associations. Each respective association may be represented in the scanner definition string by a respective indicator. The processing may include saving a mapping between each indicator and a respective action-pointer. Each respective indicator may include a respective index and/or a respective number representing a respective pointer.

The scanner definition string may have the format of a scanner definition file of a scanner generator, for example a Flex scanner generator.

The processing may include inputting the scanner definition string into a scanner generator core modified for processing the scanner definition string so as to form a processed scanner definition data structure. In this regard, the scanner generator core may be a Flex scanner generator core. The processing may include converting the processed scanner definition data structure into the scanner data structure.

A respective indicator representing the respective association between each of the plurality of patterns and the respective executable action may be included in the scanner data structure. Each respective indicator may include an index and/or a pointer.

The processing may include saving the scanner definition string and the scanner data structure, for example, to a persistent memory device. Additionally, the processing may include saving a mapping between the scanner definition string and the scanner data structure, also, for example, to a persistent memory device.

The method according to the present invention for generating a scanner may further include receiving a definition of a plurality of second patterns and receiving a definition of a respective second association between each of the plurality of second patterns and a respective second executable action. Each of the plurality of second patterns and the respective second association may be processed so as to determine a second scanner data structure capable of comparing the input data to each of the plurality of second patterns and causing execution of the respective second executable action upon a match of the input data with a one of the plurality of second patterns. Such processing may be performed in a same second active process and may include forming a second scanner definition string from the plurality of second patterns and respective second associations, and comparing the second scanner definition string to the saved scanner definition string and loading the saved scanner data structure as the second scanner data structure when the second scanner definition string matches the saved scanner definition string.

The saved scanner definition string and the second scanner definition string may have a format of a scanner definition file of a scanner generator, for example, a Flex scanner generator.

Loading the saved scanner data structure as the second scanner data structure may be performed using the mapping between the scanner definition string and the scanner data structure.

In some embodiments of the present invention, the second scanner definition string may be input into a scanner generator core so as to form a processed scanner definition data structure when the second scanner definition string does not match the saved scanner definition string. The scanner generator core may be a Flex scanner generator core. The processed scanner definition data structure may be converted into the second scanner data structure.

The second scanner definition string and the second scanner data structure, as well as a mapping between the second scanner definition string and the second scanner data structure, may be saved.

The method according to the present invention for generating a scanner may further include associating at least one respective start state of a plurality of start states with each of the plurality of patterns. A current start state may be set, the current start state being one of the plurality of start states. The processing of the plurality of patterns and associations with respective executable actions may be performed so that each respective start state is processed along with each associated pattern so as to form a part of the scanner data structure, with the comparing of the input data being performed so as to compare only the patterns associated with a respective start state equal to the current start state.

Setting the current start state may be performed so as to reset the current start state to another one of the plurality of start states at least once during the comparing operation. The resetting may be performed using at least one of the executable actions. In some embodiments of the present invention, a stack of the start states may be maintained, with the current start state being the top of the stack.

For controlling the respective start state, a respective context may be associated with each of the start states. Each context may include at least one respective rule defining a start of the context and at least one respective rule defining an end of the context.

The input data may include a data stream.

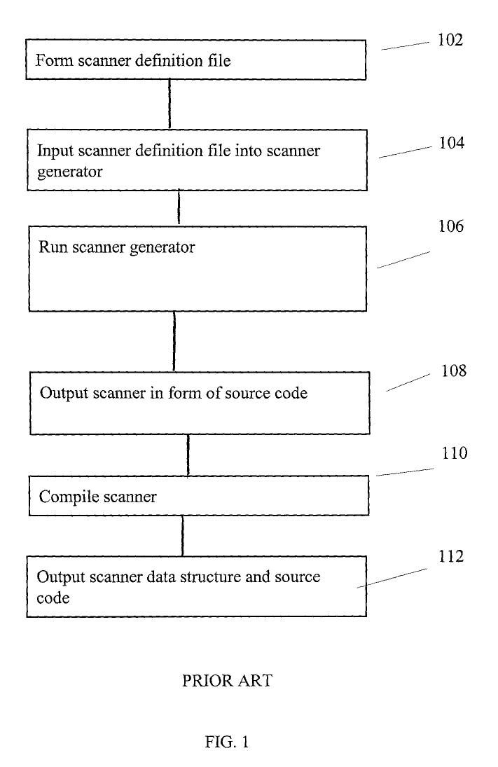

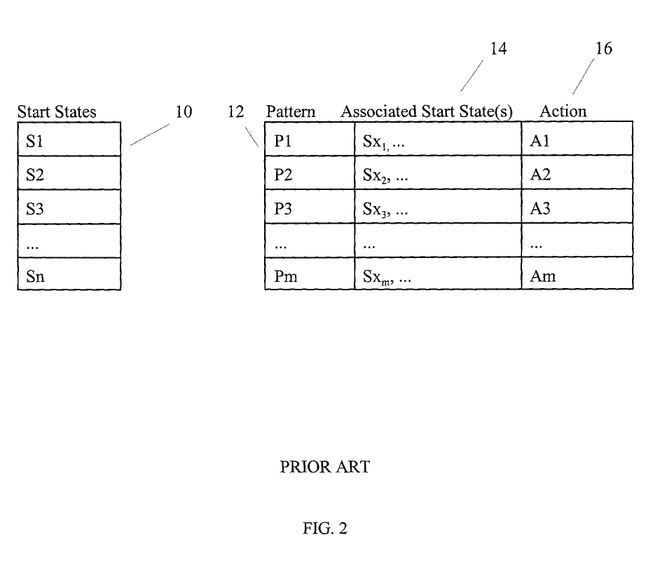

FIG. 1 shows a flow chart of a prior art method for generating a scanner. First, a scanner definition file is formed (Step 102). Referring to FIG. 2, the scanner definition file includes list of start states 10 and list of patterns 12. Associated with each pattern is a set of start states 14, selected from list 10, and an action 16 in the form of source code or text. The set of start states 14 associated with each pattern serves a control function during running of the generated scanner. When the start state is present, then the associated pattern is active, i.e., the scanner compares input data with that pattern (as well as any other active patterns); when the start state is not present, then the associated pattern is inactive, and that pattern is not included in the comparing process.

Next, the scanner definition file formed in step 102 is inputted into a scanner generator (Step 104). The scanner generator is then run (Step 106). The scanner generator typically includes a core and an output subsystem. The core processes the scanner definition file and generates a data structure which includes a variant of a finite state automaton and associations from some states of this automaton to source code text of executable actions associated with the patterns. The output subsystem outputs this data structure in the form of source code, combining a scanner skeleton with the source code text of the executable actions and outputting this combined source code as well.

A scanner in the form of source code is then output (Step 108). The scanner output in Step 108 includes serialized data-structures in the form of source code (constant definitions), as well as source code in which the actions set forth in the scanner definition file in Step 102 are present in verbatim form.

Next, the generated scanner is compiled (Step 110). Then, at least one object, or executable, file including the scanner data structure and the compiled source code (scanner skeleton combined with executable actions) are output (Step 112). The scanner data structure is usually (depending on the specific compiler used) in the form of raw data, and the compiled source code is in machine language. The scanner is ready to be linked to the object code of other program components, or to be run as a stand-alone scanner.

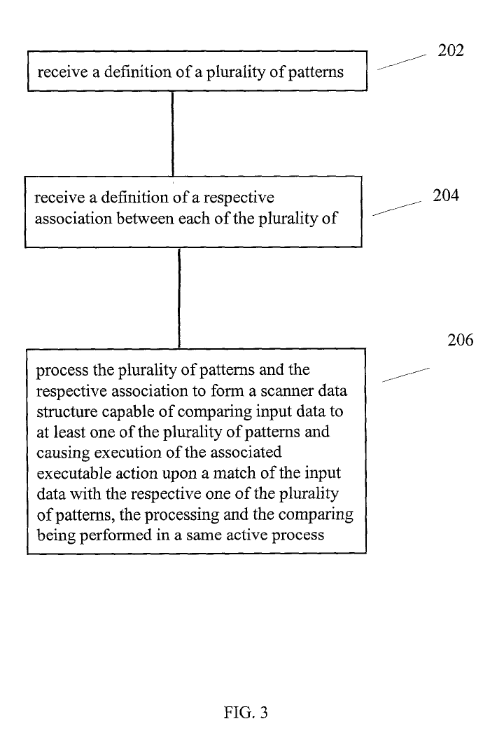

FIG. 3 shows a flow chart of a method for generating a scanner in accordance with an embodiment of the present invention. First a definition of a plurality of patterns is received (Step 202). The patterns may include regular expressions, text patterns, or other arrangements of characters, symbols, etc., for which it is desired to search input data. The patterns may be defined by entering each pattern into a file, table or array in a memory structure, for example. The input data may be a data stream, data file, or any suitable data which can be read in.

Next, a definition of a respective association between each of the plurality of patterns and a respective executable action is received (Step 204). Each association may take the form of a pointer, an action-pointer, an index, or any suitable means of associating a pattern with a respective executable action. The receiving a definition of the associations may be performed in the same active process as the processing of the patterns and associations, as described below. Each executable action may include a respective action object, program code and/or data. In some embodiments of the present invention, an action object may be generated in the same active process as the active process in which the patterns and associations are processed, as described below.

Each of the plurality of patterns and the respective associations are then processed so as to form a scanner data structure capable of comparing input data to each of the plurality of patterns and causing execution of the associated executable action upon a match of the input data with the respective one of the plurality of patterns, with the processing and the comparing being performed in the same active process (Step 206). As noted above, the receiving a definition of and processing of the patterns and associated executable actions may occur in the same active process. Additionally, when the executable action includes an action object, the action object may be generated in the same active process. As action objects will be familiar to those of skill in the art, no further discussion is provided here. Reference may be had, for example, to Erich Gamma et al., “Design Patterns” (ISBN 0201633612). The same “active process” may be understood here to mean a same running process with no intervening compiling, exiting to other programs, etc.

The patterns and respective associations with executable actions are preferably arranged, or loaded, into a scanner definition data structure. The scanner definition data structure may contain information analogous to the information contained in the scanner definition file for a prior art scanner generator, as shown in FIG. 2, i.e., start states, patterns with respective associated actions and respective sets of the start states. Preferably, however, according to the present invention the actions are represented in the scanner definition data structure by a pointer to an action object residing elsewhere. In other embodiments of the present invention, action pointers and/or indices may be used to represent the actions in the data structure. For example, indices to an array of action pointers may be used.

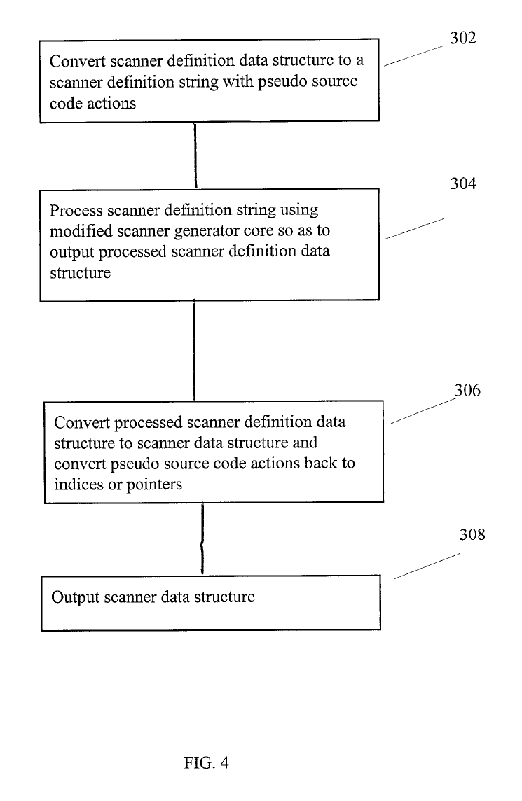

FIG. 4 shows a flow chart detailing Step 206 of the flow chart of a method for generating a scanner shown in FIG. 3. First, the scanner definition data structure is converted to a scanner definition string (Step 302). The conversion is performed by traversing the scanner definition data structure and appending appropriate text to the scanner definition string. The scanner definition string may have the same format as a scanner definition file of a prior art scanner, such as Flex, for example. The associations of the patterns and respective executable actions are represented in the scanner definition string by indicators. The indicators may include the pointers or action pointers of the scanner definition data structure converted to numbers. Alternatively, the indicators may be index numbers used directly in the scanner definition string. The indicators may be represented in the scanner definition string as a pseudo, or faked, source code

Next, the scanner definition string is processed using a modified scanner generator core so as to output a processed scanner definition data structure (Step 304). The modified scanner generator core may be a prior art scanner generator core, such as a Flex core, for example, modified to read from a string instead of a file. The output processed scanner definition data structure may have a form of a number of arrays. Within the processed scanner definition data structure the actions are represented by the verbatim text from the scanner definition data structure, i.e., numbers converted from pointers or index numbers.

The processed scanner definition data structure output from the core is then converted to a scanner data structure, with the pseudo source code actions being converted back to indices or pointers (Step 306). A scanner data structure including the pointers or indices is then output (Step 308). The output scanner data structure is ready to be used for scanning operations.

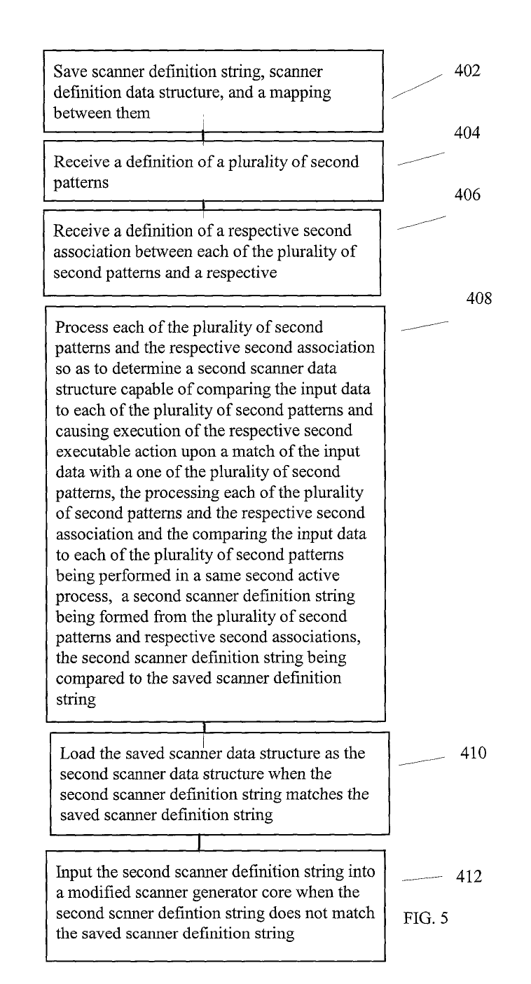

FIG. 5 shows a flow chart of a method for generating a scanner according to an embodiment of the present invention using a saved scanner data structure. First, the scanner definition string and the scanner data structure formed in Steps 302 and 304, respectively, of the processing depicted in the flow chart shown in FIG. 4 are saved (Step 402). This scanner definition string and the scanner data structure may be referred to as the “first” scanner definition string and “first” scanner data structure. A mapping between the first scanner definition string and the first scanner data structure is also saved.

The saving of the first scanner definition string and the first scanner data, as well as of the mapping between them, is preferably performed in the same active process in which the scanner definition string and scanner definition data structure are formed. These saving steps are preferably performed to a persistent memory device, such as non-volatile ram, a hard disk, etc., or combinations thereof.

Additional scanner definition strings and associated scanner data structures may also be formed and saved, along with respective mappings between them, as described below. The purpose of the mapping is to enable a fast look-up query with a new scanner definition string as the key to the map. The scanner definition data structure associated with the new scanner definition data structure is obtained as a result of the query when the new string matches the first (or another) string. The map may take the form of a hash-map or b-tree.

Next, a definition of plurality of second patterns is received (Step 404). The second patterns may include regular expressions, text patterns, or other arrangements of characters, symbols, etc., for which it is desired to search input data. A definition of a respective second association between each of the plurality of second patterns and a respective second executable action is then received (Step 406). Each second association may take the form of a pointer, an action-pointer, an index, or any suitable means of associating a pattern with a respective executable action. Each executable action may include a respective action object, program code and/or data.

Each of the plurality of second patterns and the respective second association are then processed so as to determine a second scanner data structure capable of comparing the input data to each of the plurality of second patterns and causing execution of the respective second executable action upon a match of the input data with a one of the plurality of second patterns (Step 408). The processing of each of the plurality of second patterns and the respective second association, as well as and the comparing the input data to each of the plurality of second patterns, are performed in a same second active process, which is not necessarily, but could be, the same active process as the active process described above with reference to FIG. 3. The processing each of the plurality of second patterns and the respective second association includes forming a second scanner definition string from the plurality of second patterns and respective second associations. The processing includes comparing the second scanner definition string to the saved (first) scanner definition string.

When the second scanner definition string matches the saved scanner definition string, the saved scanner data structure is loaded as the second scanner data structure when (Step 410). The loading may be performed to a memory device, such as a random access memory, for example. The saved scanner definition string and the second scanner data structure may both have the format of a scanner definition file of a scanner generator, such a Flex, for example. Preferably, the saved mapping between the saved scanner definition string and the saved scanner data structure is used to identify the saved scanner data structure corresponding to the matched (saved) scanner definition string. Using the saved scanner data structure avoids having to re-process a scanner definition string using the modified scanner generator core, as described above with reference to FIG. 4. A scanner data structure has already been generated for the matched scanner definition string has already been generated and saved. Advantageously, the saved scanner data structure may be used.

When the second scanner definition string does not match the saved scanner definition string, the second scanner definition string is input into a modified scanner generator core so as to form a processed scanner definition data structure, which is further converted to a scanner data structure (Step 412). The modified scanner generator core may be a prior art scanner generator core, such as a Flex core, for example, modified to read from a string instead of a file.

Steps 302 and 304 of FIG. 4 and step 402 of FIG. 5 may be repeated a plurality of times with (possibly different) scanner definition data structures, possibly in different active processes, so as to produce a plurality of saved scanner definition strings and associated saved scanner data structures. Each time a scanner definition data structure is generated, the corresponding scanner definition string is saved, as is a mapping between them. Thus, a dictionary of saved scanner definition strings and corresponding scanner definition data structures may be built up so as to avoid having to process, using a modified scanner generator core, a scanner definition string for which a scanner definition data structure has already been generated. Before generating a scanner definition data structure for a scanner definition string, the dictionary is checked. If the scanner definition string is in the dictionary, then the associated scanner definition data structure is found using the mapping.

Steps 404 through 412 may later, in the same or another active process, be repeated. For each plurality of second patterns, the respective scanner definition string is looked up in the dictionary of saved scanner definition strings and corresponding scanner definition data structures. When a match is found, then the respective scanner definition data structure associated with the matched scanner definition string is loaded using the mapping between them. When no match is found, then scanner definition string is input into a modified scanner generator core so as to form a processed scanner definition data structure, as described above.

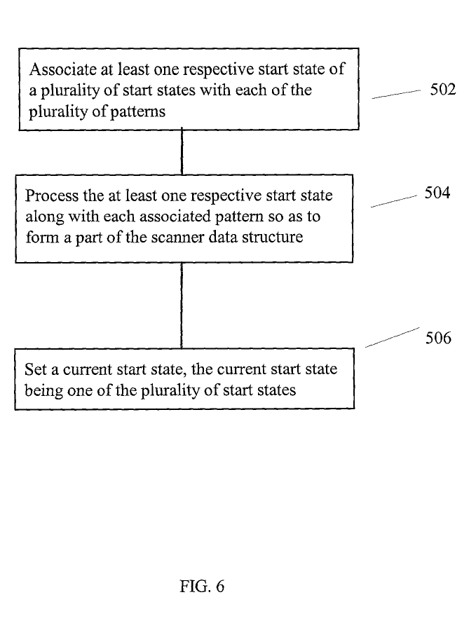

FIG. 6 shows a flow chart of a method for generating a scanner according to an embodiment of the present invention using start states associated with patterns to be scanned for. At least one respective start state of a plurality of start states is associated with each of the plurality of patterns (Step 502), the definition of the plurality of patterns being received in Step 202 of the method depicted in the flowchart of FIG. 3 and discussed above. The plurality of start states may form part of the scanner definition data structure which includes the patterns and associated executable actions, as described above with reference to FIG. 3. A subset of the start states may be associated with each pattern in the scanner definition data structure.

At least one respective start state is processed along with each associated pattern so as to form a part of the scanner data structure (Step 504). The processing of Step 504 is performed as part of the processing Step 206 of the method depicted in the flowchart of FIG. 3 and discussed above. A current start state is set, the current start state being one of the plurality of start states (Step 506). The current start state may change during a scanning process. An initial value for the current start state may be set at the start of a scanning process.

According to an embodiment of the present invention, the current start state may be set using a stack of the start states, the current start state being defined as the start state at the top of the stack. The stack ordering may be controlled in any of a variety of suitable ways. For example, the stack could be modified as a part of an execution of one of the executable actions. The current start state and the stack only exist during scanning, i.e., during the comparing of input data to at least one of the plurality of patterns, so as to compare only the patterns associated with a respective start state equal to the current start state. The start states may thus be used as a way to control when particular patterns are “active,” i.e., being scanned for in the scanning process. By appropriate control of the stack, the current start state may be changed as the scanning process progresses.

In some embodiments of the present invention, instead of using start states directly, a construct, hereby denoted as a “context,” may be used to control when a given pattern is active for searching by the scanner. A context is associated with a respective start state, there being a one-to-one relationship between a context and the corresponding start state. A start state is included in some rules (or actions associated with patterns). A context includes rules defining where the context starts and ends. Starting a context means pushing the corresponding start state onto a start state stack. Ending the context means popping the start state from the stack. Using contexts prevents a user trying to pop a start state from an empty stack. Additionally, using contexts increases user friendliness as contexts may be more intuitive than start states and a stack.

The scanner according to the present invention may find application in any suitable application in which a scanner may be employed, such as a compiler front end, a syntax-highlighting editor, a parser and a parser filter, as well as a text stream filter such as that described in the application for patent entitled “Text Stream Filter,” applicant docket number 218.1023, filed on even date herewith and assigned to the applicant, and which is hereby incorporated by reference herein.

The present invention may be carried out on any suitable computing platform, such as UNIX™, Solaris™, SunOS™, LINUX™, Microsoft Windows™, etc.

The present invention has been described herein with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for generating a scanner, the method comprising:
receiving a definition of a plurality of patterns;
receiving a definition of a respective association between each of the plurality of patterns and a respective executable action; and
processing the plurality of patterns and the respective associations to form a scanner data structure capable of comparing input data to at least one of the plurality of patterns and causing execution of the associated executable action upon a match of the input data with the respective one of the plurality of patterns, the processing and the comparing being performed in a same active process.

2. The method as recited in claim 1 wherein the scanner is capable of being used for at least one of a compiler front end, a syntax-highlighting editor, a text stream editor, a parser and a parser-filter.

3. The method as recited in claim 1 wherein the receiving the definition of the plurality of patterns is performed in the same active process.

4. The method as recited in claim 1 wherein the plurality of patterns include regular expressions.

5. The method as recited in claim 1 wherein the plurality of patterns include text patterns.

6. The method as recited in claim 1 wherein the receiving the definition of the respective association is performed in the same active process.

7. The method as recited in claim 1 wherein each respective association between each of the plurality of patterns and the respective executable action includes a pointer.

8. The method as recited in claim 1 wherein each respective association between each of the plurality of patterns and the respective executable action includes an index number.

9. The method as recited in claim 1 wherein at least one of the respective executable action includes a respective action object.

10. The method as recited in claim 1 wherein at least a portion of at least one of the respective executable action is generated in the same active process.

11. The method as recited in claim 1 wherein at least one of the respective executable action includes respective program code.

12. The method as recited in claim 1 wherein at least one of the respective executable action includes respective data.

13. The method as recited in claim 1 wherein the processing includes forming a scanner definition string from the plurality of patterns and respective associations.

14. The method as recited in claim 13 wherein each respective association is represented in the scanner definition string by a respective indicator.

15. The method as recited in claim 14 wherein the processing further includes saving a mapping between each respective indicator and a respective action-pointer.

16. The method as recited in claim 14 wherein each respective indicator includes a respective index.

17. The method as recited in claim 14 wherein each respective indicator includes a respective a number representing a respective pointer.

18. The method as recited in claim 13 wherein the scanner definition string has a format of a scanner definition file of a scanner generator.

19. The method as recited in claim 18 wherein the scanner generator is a Flex scanner generator.

20. The method as recited in claim 18 wherein the processing further includes inputting the scanner definition string into a scanner generator core modified for processing the scanner definition string so as to form a processed scanner definition data structure.

21. The method as recited in claim 20 wherein the scanner generator core is a Flex scanner generator core.

22. The method as recited in claim 20 wherein the processing further includes converting the processed scanner definition data structure into the scanner data structure.

23. The method as recited in claim 1 wherein the scanner data structure includes a respective indicator representing the respective association between each of the plurality of patterns and the respective executable action.

24. The method as recited in claim 23 wherein each respective indicator includes an index.

25. The method as recited in claim 23 wherein each respective indicator includes a pointer.

26. The method as recited in claim 13 wherein the processing further includes saving the scanner definition string and the scanner data structure.

27. The method as recited in claim 26 wherein the saving is performed to a persistent memory device.

28. The method as recited in claim 26 wherein the processing further includes saving a mapping between the scanner definition string and the scanner data structure.

29. The method as recited in claim 28 wherein the saving is performed to a persistent memory device.

30. The method as recited in claim 28 further comprising:
receiving a definition of a plurality of second patterns;
receiving a definition of a respective second association between each of the plurality of second patterns and a respective second executable action;
processing the plurality of second patterns and the respective second associations so as to determine a second scanner data structure capable of comparing the input data to each of the plurality of second patterns and causing execution of the respective second executable action upon a match of the input data with a one of the plurality of second patterns, the processing each of the plurality of second patterns and the respective second association and the comparing the input data to each of the plurality of second patterns being performed in a same second active process;
wherein the processing each of the plurality of second patterns and the respective second association includes:
forming a second scanner definition string from the plurality of second patterns and respective second associations; and
comparing the second scanner definition string to the saved scanner definition string and loading the saved scanner data structure as the second scanner data structure when the second scanner definition string matches the saved scanner definition string.

31. The method as recited in claim 30 wherein the saved scanner definition string and the second scanner definition string have a format of a scanner definition file of a scanner generator.

32. The method as recited in claim 31 wherein the scanner generator is a Flex scanner generator.

33. The method as recited in claim 30 wherein the loading the saved scanner data structure as the second scanner data structure is performed using the mapping between the scanner definition string and the scanner data structure.

34. The method as recited in claim 30 further comprising inputting the second scanner definition string into a scanner generator core so as to form a processed scanner definition data structure when the second scanner definition string does not match the saved scanner definition string.

35. The method as recited in claim 34 wherein the scanner generator core is a Flex scanner generator core.

36. The method as recited in claim 34 wherein the processing further includes converting the processed scanner definition data structure into the second scanner data structure.

37. The method as recited in claim 30 wherein the processing further includes saving the second scanner definition string and the second scanner data structure.

38. The method as recited in claim 37 wherein the processing further includes saving a mapping between the second scanner definition string and the second scanner data structure.

39. The method as recited in claim 1 further comprising:
associating at least one respective start state of a plurality of start states with each of the plurality of patterns; and
setting a current start state, the current start state being one of the plurality of start states;
wherein the processing includes processing the at least one respective start state along with each associated pattern so as to form a part of the scanner data structure, the comparing being performed so as to compare only the patterns of the plurality of patterns associated with a respective start state equal to the current start state.

40. The method as recited in claim 39 wherein the setting the current start state is performed so as to reset the current start state to another one of the plurality of start states at least once during the comparing.

41. The method as recited in claim 40 wherein the current start state is reset using at least one of the respective executable action.

42. The method as recited in claim 40 further comprising maintaining a stack of the plurality of start states, the current start state being the top of the stack.

43. The method as recited in claim 39 further comprising associating a respective context with each of the plurality of start states for controlling the respective start state.

44. The method as recited in claim 43 wherein each context includes at least one respective rule defining a start and an end of the context.

45. The method as recited in claim 39 further comprising maintaining a stack of the plurality of start states, the current start state being the top of the stack, each of the context for controlling a position of the respective start state in the stack.

46. The method as recited in claim 1 wherein the input data includes a data stream.

47. A method for scanning input data, the method comprising:
receiving a definition of a plurality of patterns;
receiving a definition of a respective association between each of the plurality of patterns and a respective executable action;
processing the plurality of patterns and the respective associations so as form a scanner data structure;
comparing the input data to the a plurality of patterns using the scanner data structure; and
when the comparing results in a matched one of the a plurality of patterns, executing the respective executable action associated with the matched pattern;
wherein the processing and the comparing are performed in a same active process.

48. The method as recited in claim 47 wherein the scanning is performed in at least one of a compiler front end, a syntax-highlighting editor, a text stream editor, a parser and a parser-filter.

49. The method as recited in claim 47 further comprising receiving the definition of the plurality of patterns in the same active process.

50. The method as recited in claim 47 wherein the receiving a definition of the respective association between each of the plurality of patterns and the respective executable action is performed in the same active process.

51. The method as recited in claim 47 wherein at least one of the respective executable action includes a respective action object.

52. The method as recited in claim 47 wherein at least a portion of at least one of the respective executable action is generated in the same active process.

53. The method as recited in claim 47 wherein the processing includes forming a scanner definition string from the plurality of patterns and respective associations.

54. The method as recited in claim 47 wherein the processing further includes inputting the scanner definition string into a scanner generator core modified for processing the scanner definition string so as to form a processed scanner definition data structure.

55. The method as recited in claim 54 wherein the processing further includes converting the processed scanner definition data structure into the scanner data structure.

56. The method as recited in claim 53 wherein the processing further includes saving the scanner definition string and the scanner data structure.

57. The method as recited in claim 56 wherein the processing further includes saving a mapping between the scanner definition string and the scanner data structure.

58. The method as recited in claim 57 further comprising:
receiving a definition of a plurality of second patterns;
receiving a definition of a respective second association between each of the plurality of second patterns and a respective second executable action;
processing the plurality of second patterns and the respective second associations so as to determine a second scanner data structure capable of comparing the input data to each of the plurality of second patterns and causing execution of the respective second executable action upon a match of the input data with a one of the plurality of second patterns, the processing each of the plurality of second patterns and the respective second association and the comparing the input data to each of the plurality of second patterns being performed in a same second active process;
wherein the processing each of the plurality of second patterns and the respective second association includes:
forming a second scanner definition string from the plurality of second patterns and respective second associations; and
comparing the second scanner definition string to the saved scanner definition string and loading the saved scanner data structure as the second scanner data structure when the second scanner definition string matches the saved scanner definition string.

59. The method as recited in claim 58 wherein the loading the saved scanner data structure as the second scanner data structure is performed using the mapping between the scanner definition string and the scanner data structure.

60. The method as recited in claim 58 further comprising inputting the second scanner definition string into a scanner generator core so as to form a processed scanner definition data structure when the second scanner definition string does not match the saved scanner definition string.

61. The method as recited in claim 47 further comprising:
associating at least one respective start state of a plurality of start states with each of the plurality of patterns; and
setting a current start state, the current start state being one of the plurality of start states;
wherein the processing includes processing the at least one respective start state along with each associated pattern so as to form a part of the scanner data structure, the comparing being performed so as to compare only the patterns of the plurality of patterns associated with a respective start state equal to the current start state.

62. The method as recited in claim 61 further comprising associating a respective context with each of the plurality of start states for controlling the respective start state.

63. The method as recited in claim 62 wherein each respective context includes at least one rule defining a start and an end of the context.

64. A scanner comprising:
a scanner data structure including processed information for a plurality of patterns and respective indicators for associating a respective executable action with each of the a plurality of patterns, the scanner data structure being capable of being used to compare input data to the plurality of patterns and cause execution of the respective executable action upon a match of the input data with a one of the a plurality of patterns, the scanner data structure being formed and the comparing being performed in a same active process.

65. The scanner as recited in claim 64 wherein the scanner is capable of being used for at least one of a compiler front end, a syntax-highlighting editor, a text stream editor, a parser and a parser-filter.

66. The scanner as recited in claim 64 wherein a definition of the plurality of patterns is received in the same active process.

67. The scanner as recited in claim 64 wherein a definition of each of the respective indicator is received in the same active process.

68. The scanner as recited in claim 64 wherein at least one of the respective executable action includes a respective action object.

69. The scanner as recited in claim 64 wherein at least a portion of at least one of the respective executable action is generated in the same active process.

70. The scanner as recited in claim 64 wherein the scanner definition data structure is formed by a process including forming a scanner definition string from the plurality of patterns and respective associations.

71. The scanner as recited in claim 70 wherein the process further includes inputting the scanner definition string into a scanner generator core modified for processing the scanner definition string.

72. A computer readable medium having stored thereon computer executable process steps operative to perform a method for generating a scanner, the method comprising:
defining a plurality of patterns;
defining a respective association between each of the plurality of patterns and a respective executable action; and
processing the plurality of patterns and the respective associations so as to form a scanner data structure capable of comparing input data to each of the plurality of patterns and causing execution of the respective executable action upon a match of the input data with a one of the plurality of patterns, the processing and the comparing being performed in a same active process.

73. The computer readable medium as recited in claim 72 wherein the scanner is capable of being used for at least one of a compiler front end, a syntax-highlighting editor, a text stream editor, a parser and a parser-filter.

74. The computer readable medium as recited in claim 72 wherein the method further comprises defining the plurality of patterns in the same active process.

75. The computer readable medium as recited in claim 72 wherein the defining the respective association between each of the plurality of patterns and the respective executable action is performed in the same active process.

76. The computer readable medium as recited in claim 72 wherein at least one of the respective executable action includes a respective action object.

77. The computer readable medium as recited in claim 72 wherein at least a portion of at least one of the respective executable action is generated in the same active process.

78. The computer readable medium as recited in claim 72 wherein the processing includes forming a scanner definition string from the plurality of patterns and respective associations.

79. The computer readable medium as recited in claim 72 wherein the processing further includes inputting the scanner definition string into a scanner generator core modified for processing the scanner definition string so as to form a processed scanner definition data structure.

80. The computer readable medium as recited in claim 79 wherein the processing further includes converting the processed scanner definition data structure into the scanner data structure.

81. The computer readable medium as recited in claim 78 wherein the processing further includes saving the scanner definition string and the scanner data structure.

82. The computer readable medium as recited in claim 81 wherein the processing further includes saving a mapping between the scanner definition string and the scanner data structure.

83. The computer readable medium as recited in claim 82 further comprising:
defining a plurality of second patterns;
defining a respective second association between each of the plurality of second patterns and a respective second executable action;
processing the plurality of second patterns and the respective second associations so as to determine a second scanner data structure capable of comparing the input data to each of the plurality of second patterns and causing execution of the respective second executable action upon a match of the input data with a one of the plurality of second patterns, the processing each of the plurality of second patterns and the respective second association and the comparing the input data to each of the plurality of second patterns being performed in a same second active process;
wherein the processing each of the plurality of second patterns and the respective second association includes:
forming a second scanner definition string from the plurality of second patterns and respective second associations; and
comparing the second scanner definition string to the saved scanner definition string and loading the saved scanner data structure as the second scanner data structure when the second scanner definition string matches the saved scanner definition string.

84. The computer readable medium as recited in claim 83 wherein the loading the saved scanner data structure as the second scanner data structure is performed using the mapping between the scanner definition string and the scanner data structure.

85. The computer readable medium as recited in claim 83 further comprising inputting the second scanner definition string into a scanner generator core so as to form a processed scanner definition data structure when the second scanner definition string does not match the saved scanner definition string.

86. The computer readable medium as recited in claim 72 further comprising:
associating at least one respective start state of a plurality of start states with each of the plurality of patterns; and
setting a current start state, the current start state being one of the plurality of start states;
wherein the processing includes processing the at least one respective start state along with each associated pattern so as to form a part of the scanner data structure, the comparing being performed so as to compare only the patterns of the plurality of patterns associated with a respective start state equal to the current start state.

87. The computer readable medium as recited in claim 86 further comprising associating a respective context with each of the plurality of start states for controlling the respective start state.

88. The computer readable medium as recited in claim 87 wherein each respective context includes at least one rule defining a start and an end of the context.
